(19) United States
(12) Patent Application Publication
(10) Pub. No.: US 2006/0085755 A1
(43) Pub. Date: Apr. 20, 2006

(54) Learning supporting program having tag information function, learning supporting method, and learning supporting system

(76) Inventor: Nobuaki Arai, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/434,069

(22) Filed: May 9, 2003

(30) Foreign Application Priority Data
Dec. 19, 2001 (JP) 2001-385434

(51) Int. Cl. G06F 3/00

(52) U.S. Cl. 715/764

(57) ABSTRACT

A learning supporting system includes: a contents transmitting unit for collecting contents according to a request from a client from a database in which contents information have been stored on the basis of the request and sending them to the client; and an additional information transmitting unit for collecting tag information or marker information on the basis of the collected contents and user information included in the request from a database in which the tag information and the marker information have been stored and transmitting the collected information to the client. The client has: an additional information selecting unit for selecting the tag information or the marker information designated by the user in the transmitted tag information or marker information; and a display unit for displaying the transmitted contents and the tag information or marker information selected by the additional information selecting unit.

### BACKGROUND OF THE INVENTION

The invention relates to program, method, and system for supporting learning of the user, enabling additional information to be displayed in contents information which is displayed, and enabling the additional information to be searched.

In a learning system using the Internet, most teaching materials have been formed by an HTML and the user progresses his learning while browsing the teaching materials by using a WWW browser. The user can learn without installing any other specific software than the WWW browser into his own computer.

Techniques for adding a note to data which is shared among a plurality of users have been disclosed in JP-A-2001-52025, JP-A-7-311764, and JP-A-2001-175650. A technique of adding a comment or a mark has been disclosed in JP-A-2000-33299.

### SUMMARY OF THE INVENTION

In the case of constructing a learning system using Internet as mentioned above, it is necessary to consider an operation environment of the user. For example, when considering a situation of the learner, it is necessary to enable a comment or a mark to be added to a text or enable the user to mark in different colors. That is, it is necessary to enable the learner to freely customize the teaching materials. When considering a situation of a teacher or an answerer of questions, it is necessary to enable the questions from a learner to be easily collected and enable them to be reflected to the learner. For this purpose, it is necessary to form an environment in which necessary information can be transmitted and received between the learner and the teacher or the answerer.

It is an object of the invention to provide an environment in which the learner can use the teaching materials more easily than that by the foregoing techniques.

Another object of the invention is to provide an environment in which information can be transmitted and received more easily between the teacher or the answerer and the learner.

As one means for accomplishing the above objects, with respect to tag information or marker information obtained from information of the user, display conditions are set at a terminal of the user, thereby allowing the tag information or marker information which meet such conditions to be displayed.

As another means, the user is enabled to set color information into the tag information or marker information, so that he can visually classify tag papers and markers by colors.

As further another means, upon searching for the tag information or marker information, the user is enabled to designate the color information as a search condition.

Other objects, features and advantages of the invention will become apparent from the following description of the embodiments of the invention taken in conjunction with the accompanying drawings.

### BRIEF DESCRIPTION OF THE DRAWINGS

FIG. 1 is a constructional diagram of a system;

FIG. 2 is a diagram showing a data structure of a tag/marker information database;

FIG. 3 is a diagram showing a data structure of a user information database;

FIG. 4 is a diagram showing a data structure of tag/marker information display conditions;

FIG. 5 is a diagram showing a data structure of tag/marker information corresponding to a present WWW page;

FIG. 6 shows a login page display screen;

FIG. 7 is a diagram showing a processing procedure at the time of login;

FIG. 8 shows a display screen in a client after he logged in the system;

FIG. 9 shows a display screen of a non-user page;

FIG. 10 is a diagram showing a display procedure of tag information;

FIG. 11 is a diagram showing a display format of the tag information;

FIG. 12 shows a display screen for adding a tag and editing tag information;

FIG. 13 is a diagram showing an adding procedure of the tag;

FIG. 14 is a diagram showing an editing procedure of the tag information;

FIG. 15 is a diagram showing a switching procedure of WWW contents in the case where link information in the tag information is selected;

FIG. 16 is a diagram showing a removing procedure of the tag;

FIG. 17 is a diagram showing a display format of a marker;

FIG. 18 shows a display screen for adding the marker;

FIG. 19 is a diagram showing an adding procedure of the marker;

FIG. 20 is a diagram showing a removing procedure of the marker;

FIG. 21 shows a display screen for displaying and setting the tag/marker;

FIG. 22 shows a display screen for setting tag information search conditions;

FIG. 23 shows a display screen for displaying a search result of the tag information;

FIG. 24 is a diagram showing a search procedure of the tag information;

FIG. 25 shows a display screen for setting marker information search conditions;

FIG. 26 shows a display screen for displaying a search result of the marker information;

FIG. 27 is a diagram showing a search procedure of the marker information; and

FIG. 28 is a constructional diagram of the system.

### DESCRIPTION OF THE EMBODIMENTS

An embodiment of the invention will be described hereinbelow with reference to the drawings.

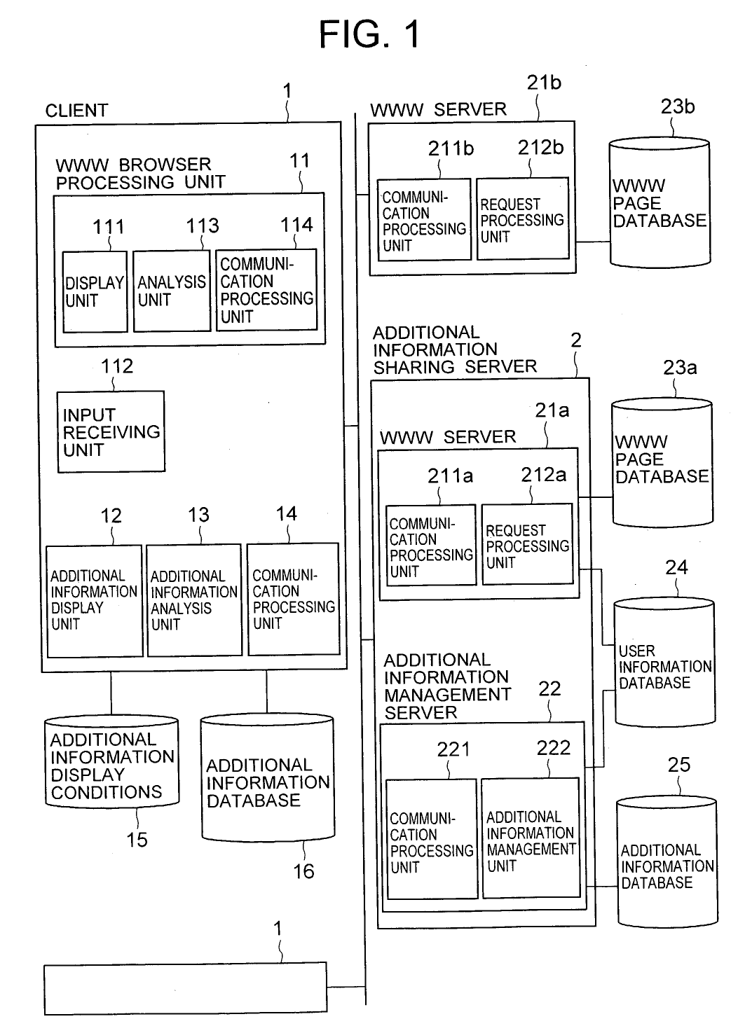

FIG. 1 shows a construction of a learning supporting system using Internet according to an embodiment of the invention. The system comprises: a plurality of clients 1 which are used as terminals by the user; and an additional information sharing server 2. The additional information sharing server 2 manages information which is shared among a plurality of clients 1. There is tag information or marker information as one of the information which is shared. Thus, the tag information or the marker information can be shared among the learners or between the learner and the teacher or the answerer. In the following explanation, “additional information” includes the tag information and the marker information and is disclosed as tag information or marker information if necessary.

The additional information sharing server 2 transmits and receives data via a network, transmits and receives data of a WWW page in accordance with an HTTP protocol, and transmits and receives tag/marker information in accordance with a communication protocol which has been predetermined between the client 1 and the additional information sharing server 2. The additional information sharing server 2 can also transmit and receive the tag/marker information in accordance with the HTTP protocol.

The client 1 has: an input receiving unit 112; a WWW browser processing unit 11; an additional information display unit 12; an additional information analysis unit 13; and a communication processing unit 14. The input receiving unit 112 receives information inputted from the user by using an input device such as keyboard, mouse, or the like and outputs position information of the mouse, information of the clicked button of the mouse, and information of a key inputted by the keyboard. The additional information analysis unit 13 processes the tag information or the marker information on the basis of the information inputted from the user. The additional information display unit 12 displays the tag information or the marker information processed by the additional information analysis unit 13. The communication processing unit 14 makes communication with the additional information sharing server 2 in accordance with a predetermined protocol.

The WWW browser processing unit 11 has: a display unit 111 for displaying WWW data; an analysis unit 113 for processing WWW page data into data which can be displayed by the display unit and processing a request received by the input receiving unit 112; and a communication processing unit 114 for communicating in accordance with the HTTP protocol.

The additional information sharing server 2 has a WWW server 21a and an additional information management server 22 and is connected to a WWW page database 23a, a user information database 24, and an additional information database 25. As a WWW page database 23a, an HTML file stored in a disk apparatus can be also used.

The WWW server 21a has: a communication processing unit 211a for communicating in accordance with the HTTP protocol; and a request processing unit 212a for processing a request according to the HTTP protocol. The WWW server 21a in the additional information sharing server 2 refers to the user information database 24 in order to confirm that the user is a legal user at the time of login.

The additional information management server 22 has: a communication processing unit 221 for communicating with the client 1 in accordance with a predetermined communication protocol; and an additional information management unit 222 for executing a managing process of the tag/marker information of a plurality of users.

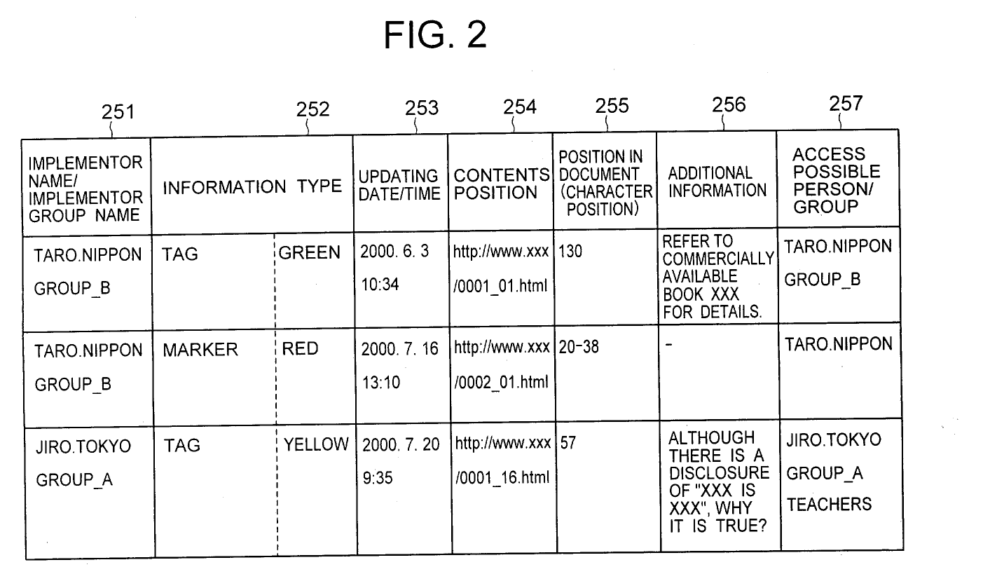

FIG. 2 shows a data structure of the additional information database 25. The tag information or the marker information is stored in this database. The additional information database 25 has the following items: an implementor name/implementor group name 251 for registering a name of an implementor of the tag information or the marker information and a name of a group to which the implementor belongs; an information type 252 showing either the tag information or the marker information and a color of the tag information or the marker information; an updating date/time 253 showing updating date/time of the tag information or the marker information; a contents position 254 showing a position of the WWW page to which the tag information or the marker information has been added; a position 255 in a document showing a position from the head of the WWW page to which the tag information or the marker information has been added; additional information 256 showing information written in the tag information; and an access possible person/group 257 for storing the names of the user and the group who can access the tag information or the marker information. If the information type 252 indicates the “marker”, the data is not stored in the additional information 256.

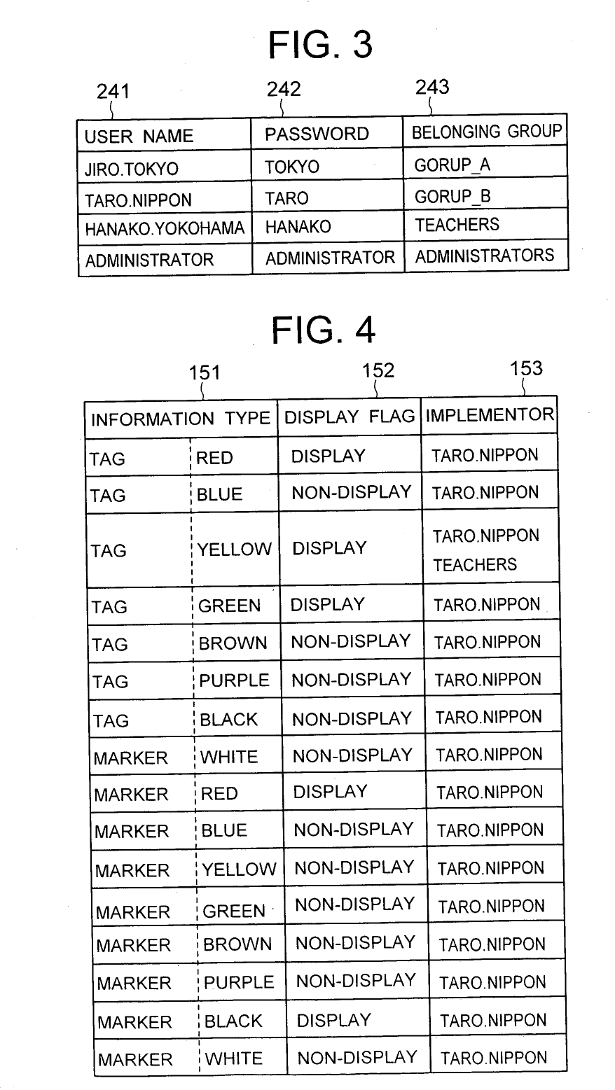

FIG. 3 shows a structure of the user information database 24. The user information database 24 is used in the case where the user logs in the system and the case where he refers to the tag/marker information. The user information has the following items: a user name 241; a password 242 corresponding to the user name; and a belonging group 243 to which the user belongs.

FIG. 4 shows a data structure of additional information display conditions 15. Those conditions are used to set a display mode of the tag/marker information or a non-display mode thereof every user. Each of the tag information and the marker information has the following items: an information type 151 showing either the tag information or the marker information and the color of the tag information or the marker information; a display flag 152 for deciding whether the tag information or the marker information is displayed or not; and an implementor 153 for storing the name of the implementor of the tag information or the marker information which is displayed and the name of the group to which the implementor belongs.

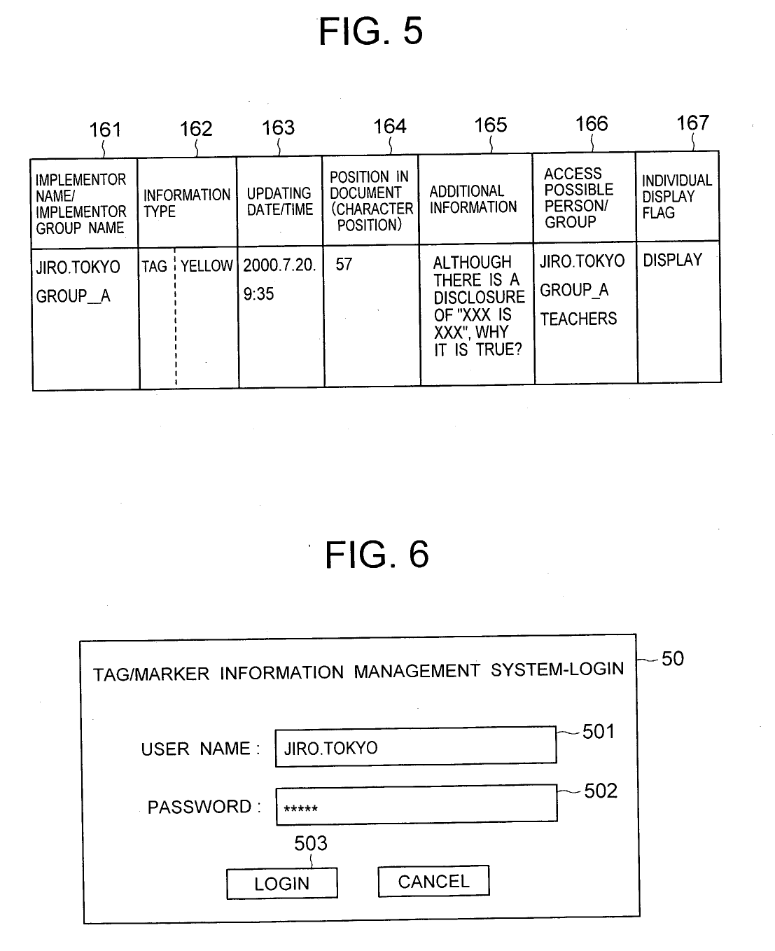

FIG. 5 shows a data structure of an additional information database 16 of the user. Each of the tag information or the marker information has the following items: an implementor name/implementor group name 161 comprising the name of the implementor of the tag/marker information and the name of the group to which the implementor belongs; an information type 162 showing either the tag information or the marker information and the color of the tag/marker information; an updating date/time 163 showing the updating date/time of the tag/marker information; a position 164 in a document showing a position based on the number of characters from the head of the WWW page to which the tag/marker information has been added; additional information 165 showing the information written in the tag information; an access possible person/group 166 for storing the name of the user and the group who can access the tag information or the marker information; and an individual display flag 167 for setting the display mode or the non-display mode on a unit basis of the tag/marker information. If the information type 162 of the tag/marker information indicates the “marker”, the data is not stored in the additional information 165.

FIG. 6 shows an example of a display of a login page 50 to the learning system. The login page 50 has: a user name input area 501 for inputting a name of the user; a password input area 502 for inputting a password of the user; and a login button 503 for inputting the start of a login process. The login page 50 is displayed on a display apparatus of the client.

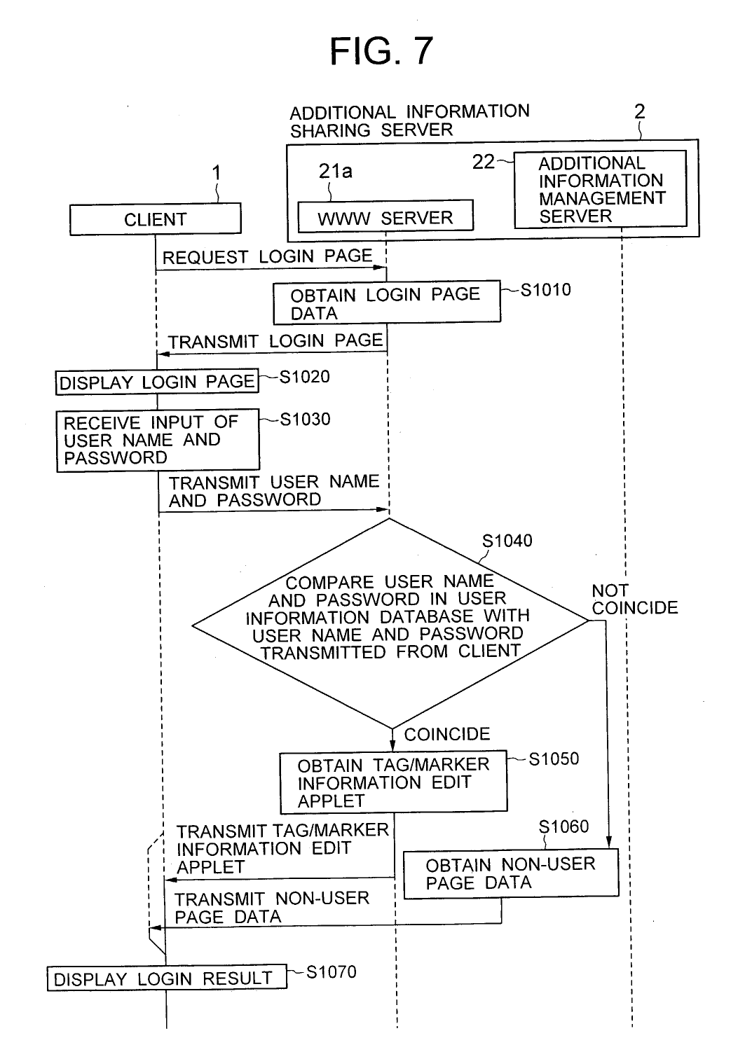

FIG. 7 shows a flow of processes at the time of login to the learning system. Although an applet is used in the embodiment, a plug-in corresponding to the WWW browser processing unit 11 can be used.

The WWW browser processing unit 11 of the client 1 requests a login page from the WWW server 21a by using the HTTP protocol by a URL for the login page of the WWW server 21a of the additional information sharing server 2.

The WWW server 21a obtains HTML data for displaying the login page 50 from the WWW page database 23a (step S1010). The WWW server 21a transmits the obtained login page 50 to the client 1 by using the HTTP protocol.

The client 1 receives the login page data transmitted from the WWW server 21a by the communication processing unit 114 of the WWW browser processing unit 11, analyzes the login page data by the analysis unit 113, and displays the login page 50 by the display unit 111 (step S1020).

The client 1 receives the user name and the password by the input receiving unit 112 (step S1030). The client 1 transmits the inputted user name and password to the WWW server 21a by using the HTTP protocol.

The WWW server 21a compares a set of the user name 241 and the password 242 of each record in the user information database 24 with a set of the user name and the password transmitted from the client 1 (step S1040).

If the coincident record exists in the user information database 24, the WWW server 21a obtains the tag/marker information applet from the WWW page database 23a (step S1050). The WWW server 21a transmits the tag/marker information applet to the client 1 via the communication processing unit 211a by using the HTTP protocol.

If the coincident record does not exist in the user information database 24, the WWW server 21a obtains non-user page data from the WWW page database 23a (step S1060). The WWW server 21a transmits the non-user page data to the client 1 via the communication processing unit 211a.

The client 1 receives the data transmitted from the WWW server 21a in step S1050 or S1060 by the communication processing unit 114, analyzes the data by the analysis unit 113, and displays it by the display unit 111 (step S1070).

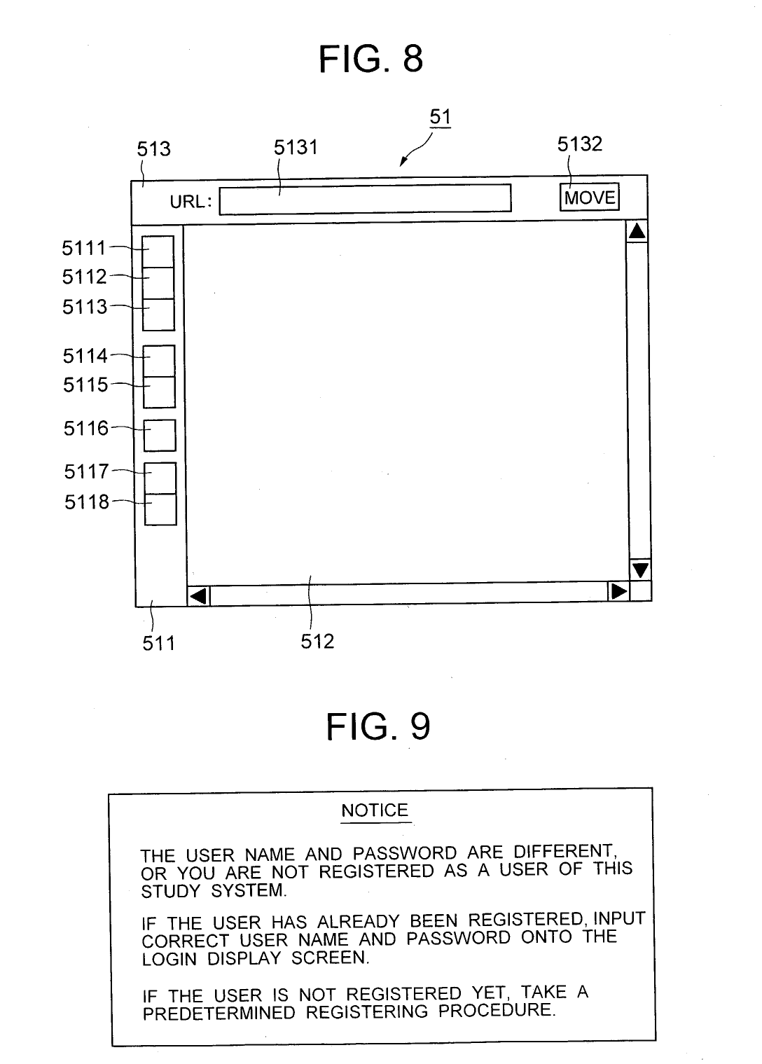

FIG. 8 shows an example of a contents display screen. The contents display screen is displayed by the tag/marker information applet received by the client 1. A contents display screen 51 has: tag/marker information edit instructing unit 511 in which buttons to edit the tag/marker information have been arranged; a WWW contents display unit 512 to display WWW contents; and a URL input unit 513 having an area for inputting a URL of the WWW contents to be displayed. The following buttons are displayed in the tag/marker information edit instructing unit 511: a tag add button 5111; a tag edit button 5112; a tag remove button 5113; a marker add button 5114; a marker remove button 5115; a tag/marker display set button 5116; a tag information search button 5117; and a marker information search button 5118. A URL input area 5131 and a move button 5132 to display a WWW page of the URL inputted to the URL input area 5131 are displayed in the URL input unit 513.

FIG. 9 shows an example of a display of a non-user page. The non-user page is transmitted from the additional information sharing server 2 when the user name and the password sent from the client to the additional information sharing server 2 are not registered in the user information database 24. Although the client 1 cannot use the addition and reference of the tag and the marker because he does not receive the tag/marker information applet, he can successively use the function as a WWW browser.

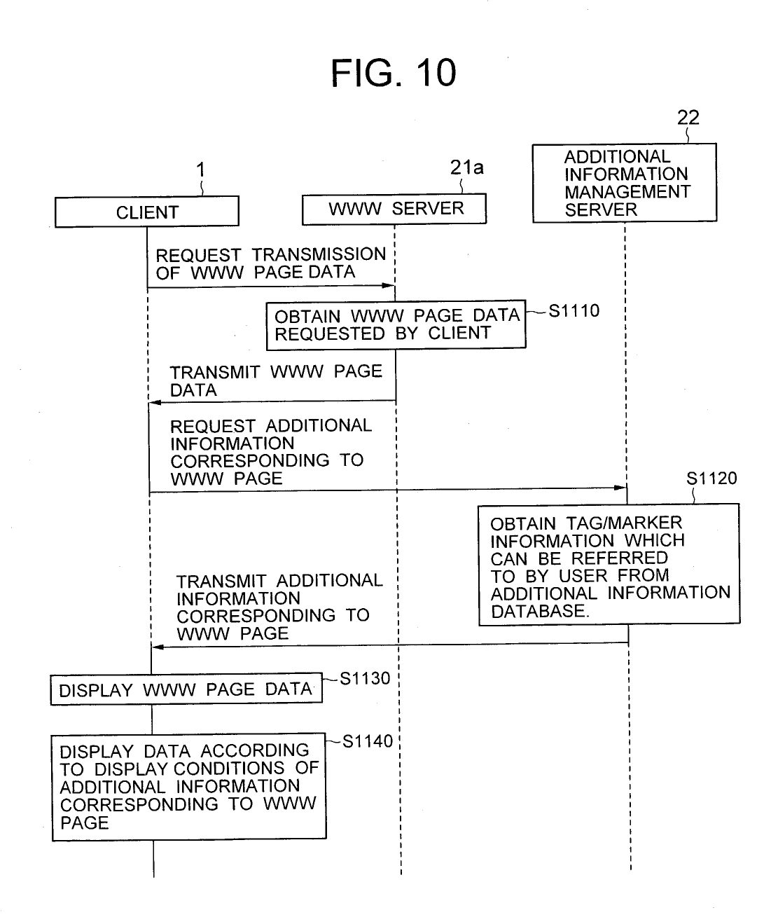

FIG. 10 shows a flow of a displaying process of the additional information.

The displaying process in the case where the additional information has already been registered into the additional information database 25 of the additional information sharing server 2 and the WWW page data has been obtained will now be described.

First, the user inputs the WWW page data which he wants to display. As a method of inputting it, there are a method of designating it by using the input device such as a mouse or the like and a method of directly inputting the URL from the keyboard.

In the case of inputting it by using the mouse, the user moves a cursor to link information displayed in the WWW contents display unit 512 and clicks a left button of the mouse. The input receiving unit 112 of the client 1 detects position information of the cursor and information showing that the left button has been clicked and transmits the position information and the information indicative of the click of the left button to the analysis unit 113. When the analysis unit 113 receives the information indicative of the click of the left button, it extracts the URL serving as link information displayed in the WWW contents display unit 512 on the basis of coordinates information. On the basis of the extracted URL, the analysis unit 113 requests the transmission of the WWW page data from the WWW server 21a in which the WWW page data exists by using the HTTP protocol.

When the user inputs the URL, he inputs it into the URL input area 5131 of the WWW contents display unit 512 by using the keyboard. When the client 1 detects the click of the move button 5132 by the input receiving unit 112, it transmits the information of the URL inputted into the URL input area 5131 to the analysis unit 113. On the basis of the inputted URL, the analysis unit 113 requests the transmission of the WWW page data from the WWW server 21a in which the WWW page data exists by using the HTTP protocol.

The WWW server 21a receives the WWW page data transmitting request by the communication processing unit 211a, analyzes it by the request processing unit 212a, and obtains the requested WWW page data from the WWW page database 23a (step S1110). The WWW server 21a transmits the obtained WWW page data to the client 1 via the communication processing unit 211a by using the HTTP protocol.

When the analysis unit 113 of the client 1 receives the WWW page data from the additional information sharing server 2, it sends the URL of the WWW page data and the user name to the additional information analysis unit 13. The additional information analysis unit 13 sends an obtaining request of the additional information corresponding to the obtained WWW page data to the additional information management server 22 via the communication processing unit 14. The URL as an existing position of the WWW page data and the user name which is at present being logged in are included in the obtaining request of the additional information.

The additional information management server 22 receives the obtaining request of the additional information by the communication processing unit 221. The additional information management unit 222 of the additional information management server 22 obtains the corresponding tag information and marker information from the contents position 254 and the access possible person/group 257 stored in the additional information database 25 and from the URL and the user name included in the obtaining request of the additional information (step S1120). Subsequently, the additional information management server 22 transmits the obtained tag information and marker information to the client 1 via the communication processing unit 221.

The client 1 analyzes the WWW page data received by the communication processing unit 114 by the analysis unit 113 and displays it as a WWW page by the display unit 111 (step S1130).

The client 1 analyzes the received tag information and marker information by the communication processing unit 14 by the additional information analysis unit 13 and stores them into the additional information database 16 of the client 1. The additional information analysis unit 13 sets the individual display flag 167 of the stored tag information and marker information into “display”. Subsequently, the additional information analysis unit 13 selects the tag information or the marker information to be displayed on the basis of the additional information display conditions 15 from the tag information and the marker information stored in the additional information database 16 of the user. Specifically speaking, between the tag information and the marker information stored in the additional information database 16 of the client 1, the information in which the individual display flag 167 indicates “display” is selected. Subsequently, the information in which the display flag 152 of the additional information display conditions 15 which coincides with the information type 162 of the selected tag information or marker information indicates “display” is selected. Further, the implementor name/implementor group name 161 of the selected tag information or marker information is compared with the implementor 153 of the additional information display conditions 15. The tag information or the marker information in which at least one same name coincides is selected. The tag information or the marker information selected as mentioned above is displayed onto the display apparatus of the client 1 by the additional information display unit 12 (step S1140). Since the additional information is displayed in the corresponding position of the WWW page, it is necessary to calculate the display position of the additional information. From the number of characters from the head of the WWW page data, coordinates at which the characters are displayed are obtained by the analysis unit 113 and the display position of the additional information is determined by the obtained coordinates.

The tag information which is displayed is determined on the basis of the color designated by the user and the user name as mentioned above.

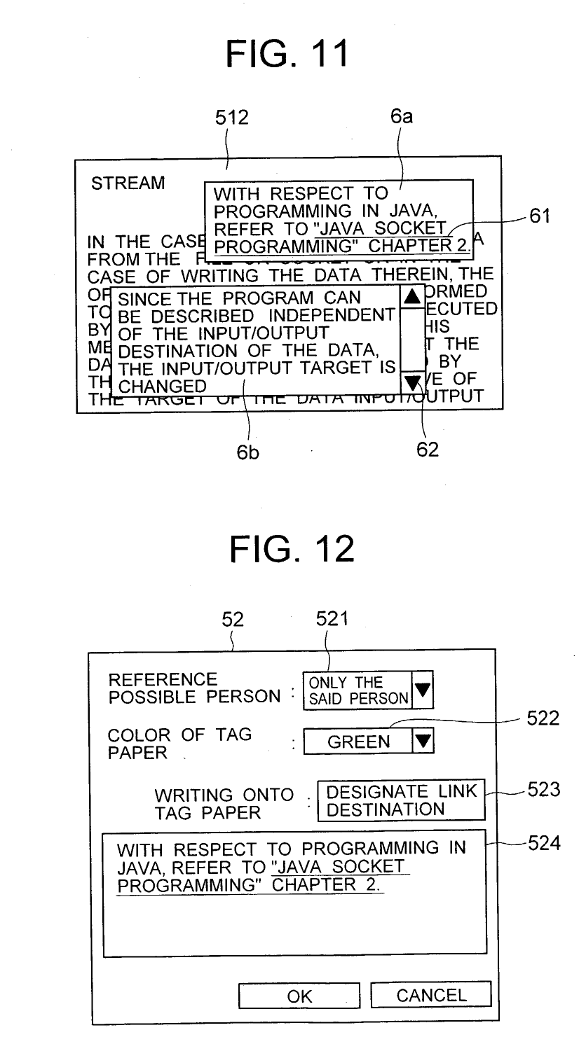

FIG. 11 shows an example of a display format of tag information 6. Link information 61 to the WWW page can be also included in the tag information. The display of the WWW page by the link information 61 is as follows. When the user moves the cursor displayed on the display apparatus by an input device such as a mouse or the like and clicks the left button of the mouse on an arbitrary character of the link information 61, position information of the cursor is sent to the additional information analysis unit 13. If it is determined from the position information that the cursor is located on the character constructing the link information 61, the additional information analysis unit 13 sends the link information 61 of tag information 6a to the analysis unit 113. The analysis unit 113 obtains the WWW page via the communication processing unit 114 and displays the WWW page onto the WWW contents display unit 512 by the display unit 111. The tag information has an area of a predetermined size and if the information written in the tag information laps out of such an area, a scroll bar 62 is added at the right end as shown in tag information 6b and by operating the scroll bar 62, hidden contents can be displayed.

There is a case where the user cannot see the characters of the WWW page data because they are hidden by the tag information. In such a case, by dragging the tag information by using the mouse, the user can display the characters hidden by the tag information. Specifically speaking, when the left button of the mouse is clicked by the user, the input receiving unit 112 of the client 1 sends the position information of the cursor to the additional information analysis unit 13. While the user moves the mouse with its left button clicked, the input receiving unit 112 keeps sending the position information of the cursor to the additional information analysis unit 13 until the click of the button of the mouse is cancelled. The additional information analysis unit 13 specifies the target tag information from the position information of the cursor which has been sent first and supplies the specified tag information and the transmitted position information to the additional information display unit 12. The additional information display unit 12 displays the tag information specified on the basis of the transmitted position information. Thus, the user can move the specified tag information by the mouse and see the characters hidden by the tag information displayed first.

After the elapse of a predetermined time after the reception of the position information of the cursor, the additional information analysis unit 13 reads out the position in the document of the specified tag information from the additional information database 16 of the user, converts it into coordinates, and supplies them to the additional information display unit 12. Thus, the tag information moved by the user is displayed in the original position after the elapse of the predetermined time.

FIG. 12 shows an example of an edit display screen 52 of the tag information. The user inputs desired items into a reference possible designation area 521, a color designation area 522, and a tag information input area 524 by using the keyboard or mouse. The reference possible designation area 521 is an area for inputting the names of the user and group who can refer to the tag information. Since the group name can be designated in the tag information as mentioned above, even if a new user is added, the tag information can be referred to by designating the group. That is, when the user is added, there is no need to change the person who can refer to the tag information. The color designation area 522 is an area for designating a display color of the tag information. The tag information input area 524 is an area for inputting a comment of the user. Further, the URL of the link destination is received by clicking a link destination designation button 523 for allowing the link information 61 to be included in the information written into the tag information. In this manner, the person who learns among the users can form the comment necessary for himself. The teacher or the answerer can form a comment which can be referred to by a plurality of learners by one tag information.

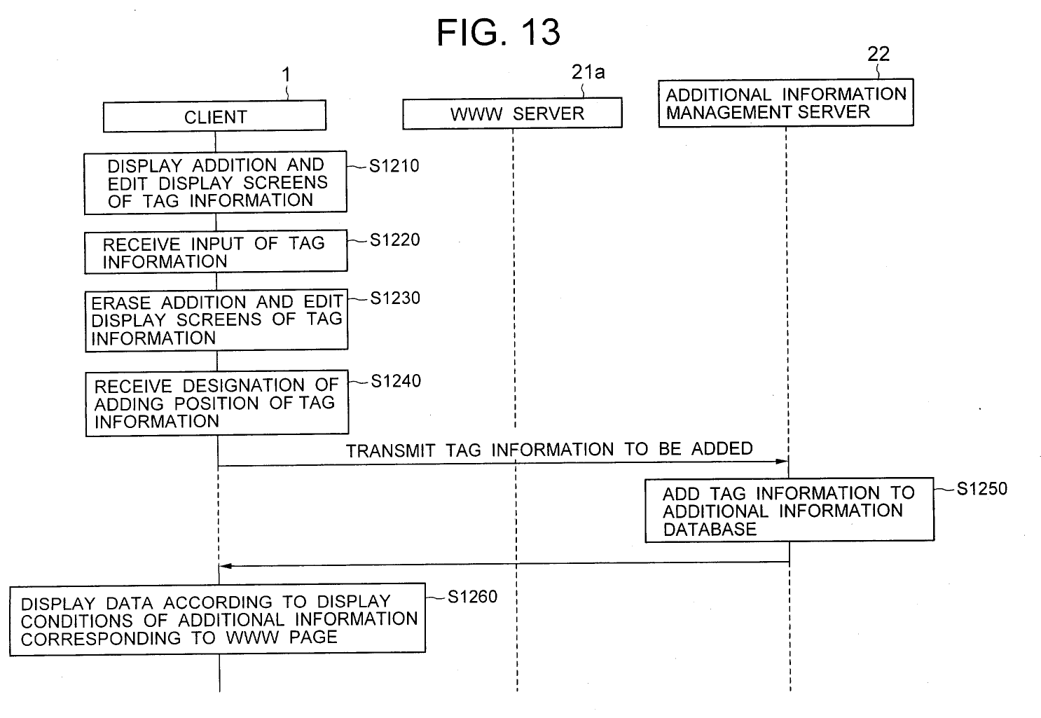

FIG. 13 shows a flow for an adding process of a tag. When the user moves the cursor to the tag add button 5111 and clicks the left button of the mouse, the input receiving unit 112 of the client 1 sends the position information of the cursor to the additional information analysis unit 13. From the position information, the additional information analysis unit 13 determines that an editing process has been selected. The additional information analysis unit 13 instructs the additional information display unit 12 to display the edit display screen 52 (step S1210).

The user inputs the names of the user and group who can refer to the tag, the display color of tag paper, the information written into the tag paper, and the link information 61 which is included in the information written into the tag paper as necessary onto the displayed edit display screen 52 by using the keyboard or mouse. The input receiving unit 112 of the client 1 receives the input information (step S1220).

When the user clicks an “OK” button on the edit display screen, the input receiving unit 112 receives it. When the additional information analysis unit 13 determines that the “OK” button has been selected on the basis of the position information sent from the input receiving unit 112, the additional information analysis unit 13 instructs the additional information display unit 12 to erase the edit display screen 52, thereby erasing the edit display screen 52 (step S1230). After that, the additional information analysis unit 13 enters a state of waiting for the input of the display position of the tag information.

Subsequently, the user selects the display position of the tag information by using the mouse. The user moves the cursor to the position where he wants to display the tag information and clicks the left button of the mouse and the additional information analysis unit 13 converts the transmitted coordinates position into a position corresponding to the number of characters from the head of the WWW page data (step S1240). The additional information analysis unit 13 transmits the user name whose login is at present being performed, the tag information received in step S1220, the WWW page data URL, and the position from the head of the WWW page data to the additional information management unit 222 by the communication processing unit 14 by using a communication protocol 32.

The additional information management unit 222 of the additional information management server 22 searches the user information database 24 by using the user name included in the transmitted information as a key, thereby extracting the name of group to which the user name serving as a key belongs. The additional information management unit 222 adds the searched group name and updating date/time information to the transmitted information and stores the resultant information into the additional information database 25 (step S1250).

The additional information management server 22 sends the tag information stored in the additional information database 25 to the client 1 on the transmitting source side.

The additional information analysis unit 13 of the client 1 compares the access possible person/group 166 and the individual display flag 167 in the additional information database 16 of the user with the display flag 152 and the implementor 153 of the additional information display conditions 15 and selects the tag information which meets the display conditions from the additional information database of the user. The additional information display unit 12 displays the tag information selected by the additional information analysis unit 13 onto the display apparatus (step S1260).

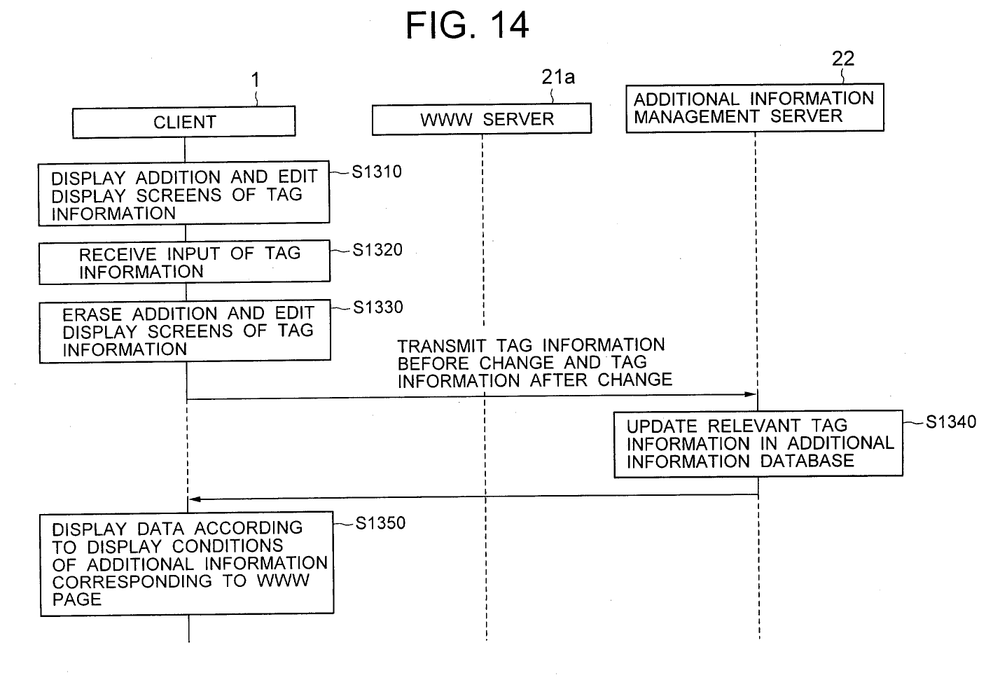

FIG. 14 shows a flow for an editing process of the tag information. The user moves the cursor to the tag edit button 5112, clicks the left button of the mouse, subsequently, moves the cursor to the tag information to be edited, and clicks the left button of the mouse. The input receiving unit 112 of the client 1 sends the position information of the cursor to the additional information analysis unit 13, respectively. From the position information, the additional information analysis unit 13 determines that a “tag edit button” has been selected. Thus, the tag information is subsequently specified from the additional information database 16 of the user on the basis of the position information which is sent next. Subsequently, the additional information analysis unit 13 reads out the information type 162, the access possible person/group 166, and the additional information 165 of the specified tag information and displays the edit display screen 52 by the additional information display unit 12 (step S1310).

The user changes the displayed information by the keyboard or mouse. The changed information is received by the input receiving unit 112 (step S1320).

When the user moves the cursor to the “OK” button and clicks the left button of the mouse, the input receiving unit 112 sends the position information of the cursor to the additional information analysis unit 13. The additional information analysis unit 13 detects that the “OK” button has been selected on the basis of the position information and instructs the additional information display unit 12 to erase the edit display screen 52 (step S1330). As tag paper information before the change and as tag paper information after the change, the additional information analysis unit 13 transmits the user name whose login is being performed at present, the tag information inputted in step S1320, the URL of the WWW page data, and the position from the head of the WWW page data to the additional information management server 22 via the communication processing unit 14 by using the communication protocol which has been predetermined between the client 1 and the additional information sharing server 2.

The additional information management server 22 receives the tag paper information before the change transmitted from the client 1 in step S1330 and the tag paper information after the change by the communication processing unit 221, changes the name of the group to which the user belongs and the updating date/time information which were obtained from the user information database 24 by the additional information management unit 222 with respect to the tag paper information after the change, and changes the tag information before the change in the tag/marker information database 25 to the tag information after the change (step S1340). The additional information management server 22 sends the changed tag information to the client 1.

The additional information analysis unit 13 of the client 1 compares the access possible person/group 166 and the individual display flag 167 in the additional information database 16 of the user with the display flag 152 and the implementor 153 of the additional information display conditions 15 and selects the tag information which meets the display conditions from the additional information database of the user. The additional information display unit 12 displays the tag information selected by the additional information analysis unit 13 onto the display apparatus (step S1350).

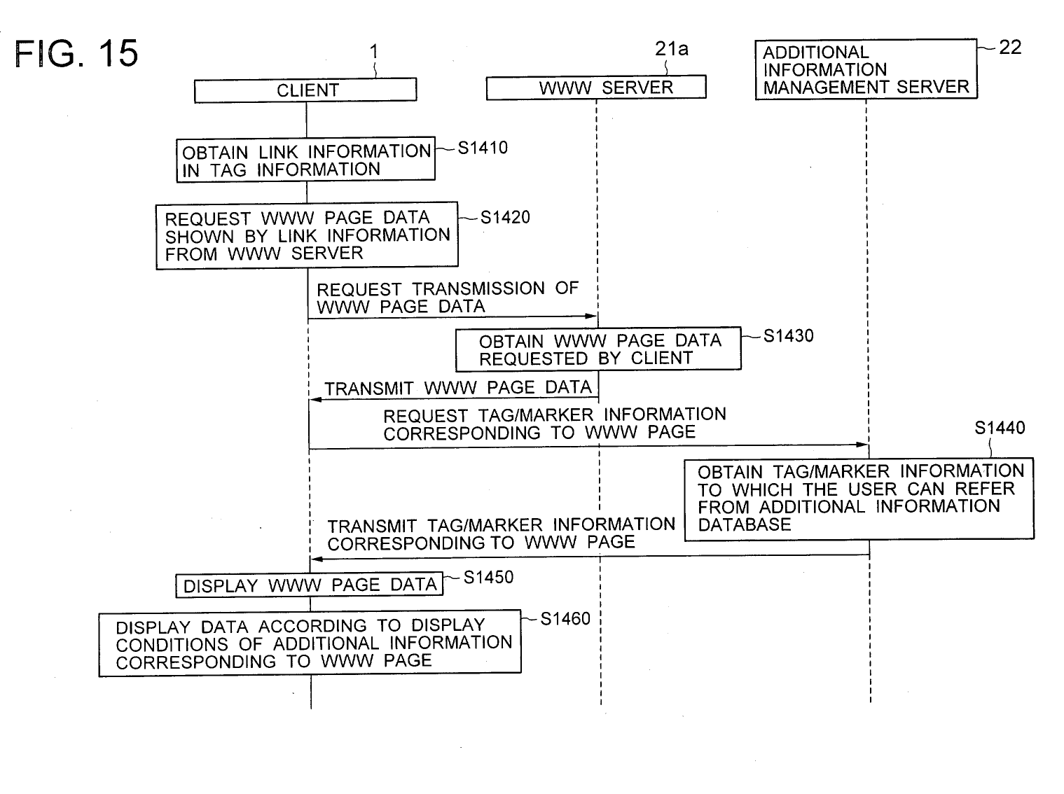

FIG. 15 shows a flow for a WWW contents switching process in the case where the link information 61 in the tag information is selected. When the fact that the link information in the tag information has been selected is received by the input receiving unit 112, the client 1 obtains the URL of the selected link information from the additional information analysis unit 13 (step S1410).

The client 1 supplies the URL to the WWW browser processing unit 11, thereby requesting the WWW page data designated by the link information from the WWW server 21a shown by the URL by using the HTTP protocol (step S1420).

The WWW server 21a receives a WWW page data transmitting request by the communication processing unit 211a, analyzes the WWW page data transmitting request by the request processing unit 212a, and obtains the requested WWW page data from the WWW page database 23a. The WWW server 21a transmits the WWW page data to the client 1 via the communication processing unit 211a by using the HTTP protocol (step S1430).

The client 1 designates the URL showing the existing position of the WWW page data and requests the additional information management server 22 to obtain the additional information corresponding to the WWW page data via the communication processing unit 14 by using the communication protocol which has been predetermined between the client 1 and the additional information sharing server 2. The additional information management server 22 receives the obtaining request of the additional information by the communication processing unit 221 and obtains the additional information to which the user can refer and which corresponds to the URL of the WWW page data from the additional information database 25 by the additional information management unit 222. Subsequently, the additional information management server 22 transmits the additional information to the client 1 via the communication processing unit 221 by using the communication protocol which has been predetermined between the client 1 and the additional information sharing server 2 (step S1440).

The client 1 receives the WWW page data by the communication processing unit 114, analyzes it by the additional information analysis unit 113, and displays it as a WWW page by the additional information display unit 12 (step S1450).

The client 1 receives the additional information by the communication processing unit 14, analyzes it by the additional information analysis unit 13, and stores it into the additional information database 16 of the user. At this time, the individual display flag 167 in the additional information database 16 of the user is set to “display”. Subsequently, by using the additional information analysis unit 13, the client 1 extracts the additional information in which the individual display flag 167 of the tag/marker information stored in the additional information database 16 of the user indicates “display”, the display flag 152 of the additional information display conditions 15 corresponding to the information type 162 of the additional information indicates “display”, and further, at least the one same name exists in the implementor name/implementor group name 161 of the additional information and the implementor 153 of the additional information display conditions 15, and the client 1 displays the extracted additional information by the additional information display unit 12 (step S1460). Although it is necessary to calculate the display position of the additional information when the analysis is executed by the additional information analysis unit 13, the display position of the additional information can be calculated by the analysis unit 113 from the correspondence between the number of characters from the head of the present WWW page data and its display position.

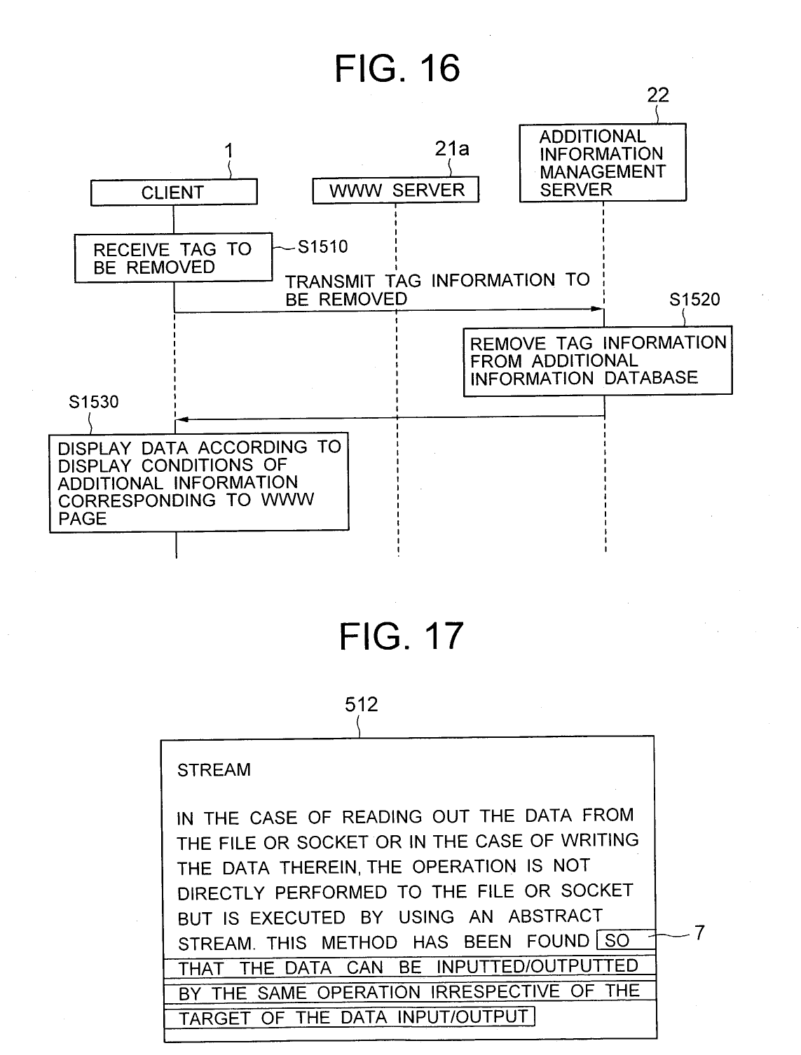

FIG. 16 shows a flow for a removing process of a tag. The user moves the cursor to the tag remove button 5113, clicks the left button of the mouse, subsequently, moves the cursor to the tag information which he wants to edit next, and clicks the left button of the mouse. The input receiving unit 112 of the client 1 transmits each position information of the cursor to the additional information analysis unit 13.

From the position information, the additional information analysis unit 13 determines that the “tag remove button” has been selected. Thus, tag information is specified from the additional information database 16 of the user on the basis of the position information which is transmitted next. Subsequently, the additional information analysis unit 13 transmits the specified tag information to the additional information management server 22 via the communication processing unit 14 by using the communication protocol which has been predetermined between the client 1 and the additional information sharing server 2 (step S1510).

The additional information management server 22 receives the transmitted tag information by the communication processing unit 221 and removes the tag information in the additional information database 25 corresponding to the transmitted tag information by the additional information management unit 222 (step S1520). The additional information management server 22 searches the additional information database 25 by using the user name as a key and sends the tag information or marker information extracted as a result of the search to the client 1.

The additional information analysis unit 13 of the client 1 compares the access possible person/group 166 and the individual display flag 167 in the additional information database 16 of the user with the display flag 152 and the implementor 153 of the additional information display conditions 15 and selects the tag information which meets the display conditions from the additional information database of the user. The additional information display unit 12 displays the tag information selected by the additional information analysis unit 13 onto the display apparatus (step S1530).

FIG. 17 shows an example of a display of a marker 7. The marker 7 is displayed in a state where a background of characters has been changed to a designated display color along a sentence of WWW contents. When the display color of the marker 7 and a display color of the sentence of the WWW contents are the same, only the marker 7 is displayed. Thus, the user can learn by painting a portion which he wants to learn by heart by the marker 7 and confirm the contents of memorization by non-displaying the marker 7.

As another method, characters designated by the marker 7 can be overwritten. By this method, even if the color changes every character, the characters can be easily seen as if they were hidden by the marker 7.

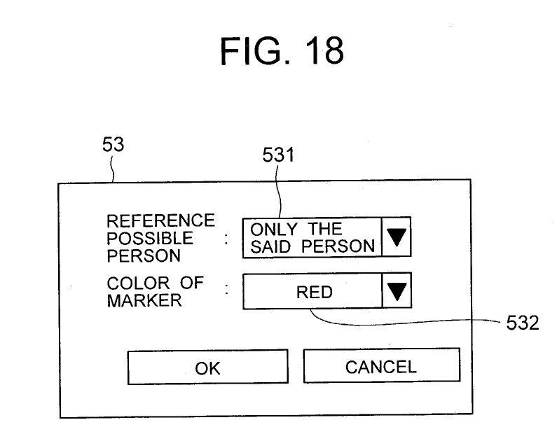

FIG. 18 shows an addition display screen 53 of the marker. The names of the user and the group who can refer to the marker are received in a reference possible person designation area 531 and the display color of the marker is received in a color designation area 532 of the marker. By constructing such that the user who can refer to the marker information can be designated by the group name, even in the case of a user who is not registered when the marker information is added, if the user belongs to the relevant group in future, he can refer to the marker information. An area for setting such that the user hides the characters by the marker can be also provided.

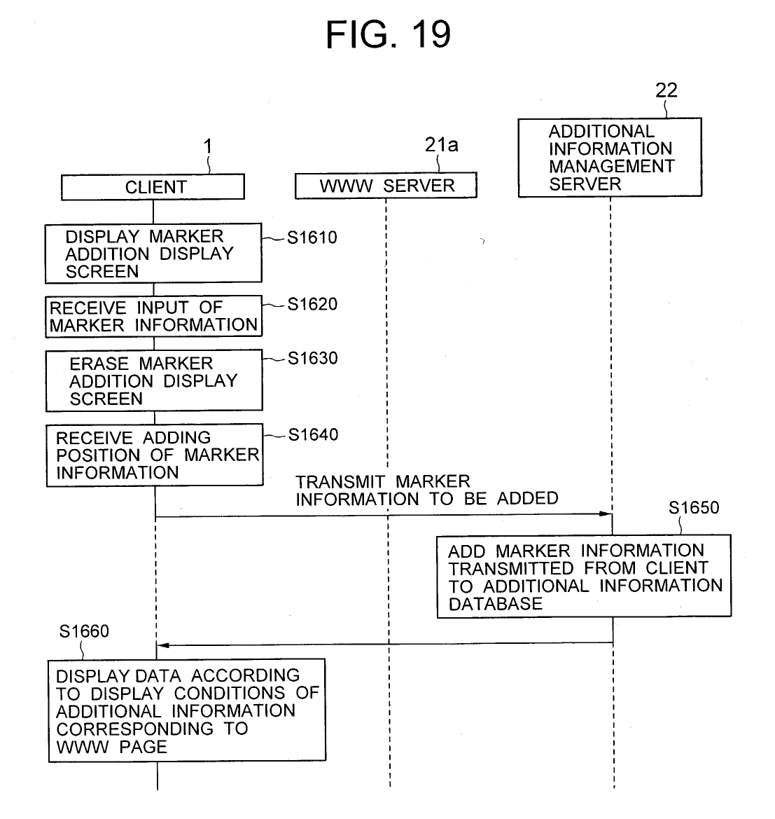

FIG. 19 shows a flow of an adding process of the marker. The user moves the cursor to the marker add button 5114 and clicks the left button of the mouse. The input receiving unit 112 of the client 1 sends the position information of the cursor to the additional information analysis unit 13. From the transmitted position information, the additional information analysis unit 13 determines that the “marker add button” has been selected and displays the addition display screen 53 of the marker by the additional information display unit 12 (step S1610).

The user inputs the names of the user and the group who can refer to the marker and the display color of the marker by using the keyboard or the mouse. The input receiving unit 112 of the client 1 receives the input from the user (step S1620).

When the user moves the cursor to the “OK” button and clicks the button of the mouse, the input receiving unit 112 transmits the position information of the cursor to the additional information analysis unit 13. From the position information, the additional information analysis unit 13 detects that the “OK” button has been selected, and instructs the additional information display unit 12 to erase the addition display screen 53 of the marker (step S1630).

The user moves the cursor by using the mouse and selects characters to which the marker is added. The user makes such a selection by dragging the target characters by the mouse. The input receiving unit 112 of the client 1 sends the detected position information to the additional information analysis unit 13. The additional information analysis unit 13 determines coordinates of the start position and the end position of the marker adding position from the transmitted position information and converts them into the start position and the end position as the number of characters from the head of the WWW page data. Subsequently, the additional information analysis unit 13 transmits the user name whose login is at present being performed, the marker information received in step S1620, the URL of the target WWW page data, and the start position and the end position from the head of the target WWW page data as marker information to be added to the additional information management server 22 via the communication processing unit 14 by using the communication protocol which has been predetermined between the client 1 and the additional information sharing server 2 (step S1640).

The additional information management server 22 receives the marker information to be added by the communication processing unit 221, adds the name of the group to which the user belongs and the updating date/time information which were obtained from the user information database 24 to the marker information to be added by the additional information management unit 222, and stores them into the additional information database 25 (step S1650). The additional information management server 22 searches the marker information stored in the additional information database on the basis of the user name and sends the searched marker information to the client 1.

The additional information analysis unit 13 of the client 1 compares the access possible person/group 166 and the individual display flag 167 in the additional information database 16 of the user with the display flag 152 and the implementor 153 of the additional information display conditions 15 and selects the marker information which meets the display conditions from the additional information database of the user. The additional information display unit 12 displays the marker information selected by the additional information analysis unit 13 onto the display apparatus (step S1660).

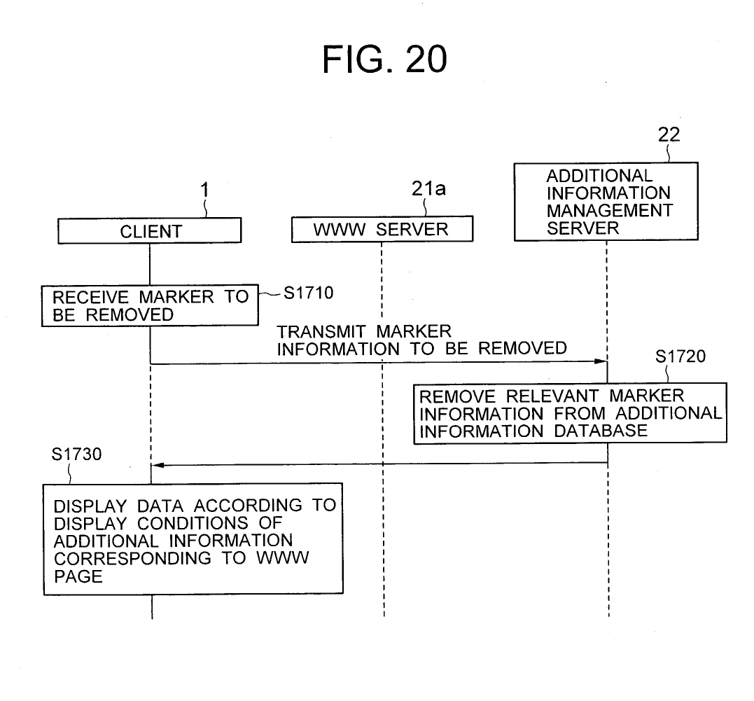

FIG. 20 shows a removing procedure of the marker. The user moves the cursor to the marker remove button 5115, clicks the left button of the mouse, subsequently moves the cursor to the marker information which he wants to remove, and clicks the left button of the mouse. The input receiving unit 112 of the client 1 sends each position information of the cursor to the additional information analysis unit 13.

From the position information, the additional information analysis unit 13 determines that the “marker remove button” has been selected. Thus, the marker information is specified from the additional information database 16 of the user on the basis of the position information which is sent next. In this case, the sent position information is converted into the number of characters from the head of the WWW page data and the information in which the converted number of characters are included in the position 164 in the document registered in the database is specified as target marker information. Subsequently, the additional information analysis unit 13 transmits the specified marker information to the additional information management server 22 via the communication processing unit 14 by using the communication protocol which has been predetermined between the client 1 and the additional information sharing server 2 (step S1710).

The additional information management server 22 receives the transmitted marker information by the communication processing unit 221 and removes the marker information in the tag/marker information database 25 corresponding to the transmitted marker information by the additional information management unit 222 (step S1720). The additional information management server 22 searches the additional information database 25 by using the user name as a key and sends the marker information extracted as a result of the search to the client 1.

The additional information analysis unit 13 of the client 1 compares the access possible person/group 166 and the individual display flag 167 in the additional information database 16 of the user with the display flag 152 and the implementor 153 of the additional information display conditions 15 and selects the marker information which meets the display conditions from the additional information database 16 of the user. The additional information display unit 12 displays the marker information selected by the additional information analysis unit 13 onto the display apparatus (step S1730).

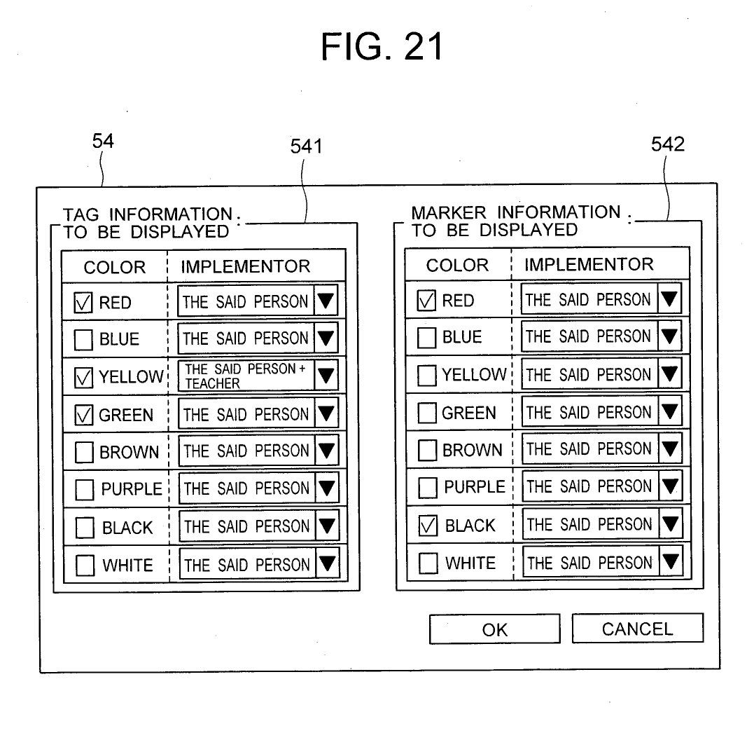

FIG. 21 shows a display setting screen 54 of a tag/marker. A display tag information setting area 541 for inputting conditions of the tag information to be displayed and a display marker information setting area 542 for inputting conditions of the marker information to be displayed are displayed on the display setting screen 54. In both of the tag information and the marker information, the implementor can be set as a display condition for each display color. The additional information display conditions 15 can be set via the display setting screen 54 of the tag/marker. Thus, the tag/marker information necessary for the user can be narrowed down and displayed.

The tag/marker information can be individually set to the “non-display” mode. The user moves the cursor to the tag or the marker by using the mouse and clicks a right button of the mouse. The input receiving unit 112 of the client 1 sends the position information of the cursor to the additional information analysis unit 13. From the sent position information, the additional information analysis unit 13 specifies the tag information or the marker information stored in the additional information database 16 of the user and instructs the additional information display unit 12 to display a pop-up menu having items of “individual display” and “all individual non-display cancel”.

When the user clicks the left button of the mouse in the WWW contents display unit 512 in which the tag or the marker is not displayed, the input receiving unit 112 of the client 1 sends the position information of the cursor to the additional information analysis unit 13. When the tag or the marker is not displayed, the additional information analysis unit 13 instructs the additional information display unit 12 to display a pop-up menu having the item of “all individual non-display cancel”. When the user moves the cursor to “individual non-display” on the displayed pop-up menu and clicks the left button of the mouse, the additional information analysis unit 13 sets the individual display flag 167 of the tag information or the marker information which has been specified before into the “non-display” mode. Thus, the tag or the marker designated by the user is erased. When the user moves the cursor to “all individual non-display cancel” and clicks the left button of the mouse, the additional information analysis unit 13 sets the individual display flag 167 of all of the tag/marker information in the additional information database 16 of the user into the “display” mode. Thus, the display of the tag/marker information can be temporarily suppressed and only the tag/marker information which is necessary for the user can be displayed.

It is also possible to use the following method of temporarily erasing the tag or the marker from the display screen.

The user moves the cursor to the tag or the marker which he wants to temporarily erase from the display screen and clicks the left button. The input receiving unit 112 of the client 1 sends the position information of the cursor and information showing that the left button has been clicked to the additional information analysis unit 13. From the sent position information, the additional information analysis unit 13 searches the additional information database 16 of the user and specifies the tag information or the marker information on the basis of the position information. When the additional information analysis unit 13 receives the information of the clicked left button, it waits for information showing that the right button of the mouse has been clicked. Subsequently, when the user clicks the right button of the mouse, the input receiving unit 112 of the client 1 sends the information showing that the right button has been clicked to the additional information analysis unit 13. The additional information analysis unit 13 sets the individual display flag 167 of the specified tag information or marker information into “non-display” and waits until the information of the left button of the mouse is sent. The tag or the marker in which the individual display flag 167 has been set into “non-display” by the additional information analysis unit 13 is erased from the display screen. If the user wants to again display the tag or the marker erased from the display screen, he clicks the left button of the mouse. When the additional information analysis unit 13 of the client 1 receives the information of the click of the left button of the mouse from the input receiving unit 112, it sets the individual display flag 167 of the specified tag information or marker information into “display”. Thus, the tag or the marker erased from the display screen is displayed again. According to the method described here, when the user clicks the left button and the right button of the mouse, the target tag or marker is erased from the display screen. However, it is also possible to detect the click of the left button of the mouse and set the individual display flag 167 into “non-display”. In the case of again displaying the tag or the marker, the user needs to click the left button of the mouse. However, if the additional information analysis unit 13 changes the individual display flag 167 from “non-display” to “display” with respect to the information after the elapse of a predetermined time, the number of operations of the user can be reduced.

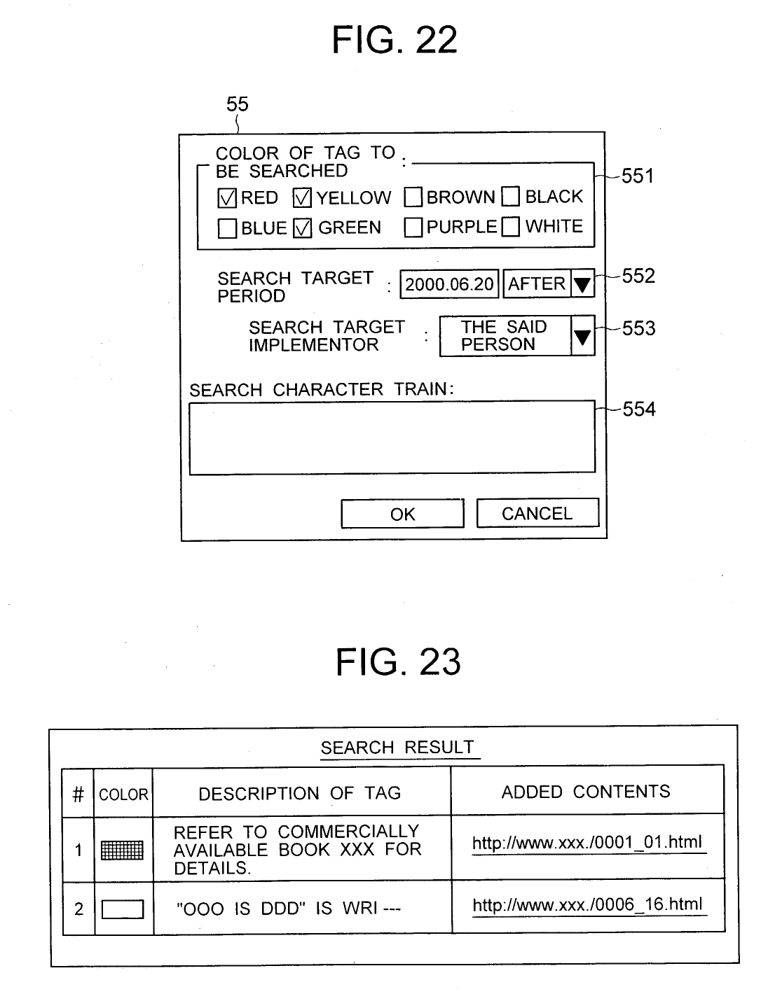

FIG. 22 shows a tag information search condition setting display screen 55. The following areas are displayed in this screen: a color designation area 551 of a tag for inputting the color of the tag information as a search target; a search target period setting area 552 for inputting a search target period; a search target person designation area 553 for inputting a search target person; and a search character train input area 554 for inputting search conditions for description of tag paper.

FIG. 23 shows a search result display screen of the tag information. The search result display screen displays the color of the tag information, the description of the tag, and the URL of the contents to which the tag information has been added. When the client 1 receives the selection of the URL of the contents to which the tag information has been added by the input receiving unit 112, it displays the contents of the URL and displays the tag or the marker which meets the set display conditions between the tag and the marker corresponding to the contents. Thus, if the learner designates the color of the tag information at the time of questioning, the teacher can extract the questions from the learner by designating the color of the tag information and the implementor excluding the teacher himself or his group. Since the tag information has been added to the positions where the learner questions in the learning materials, the learner can question for the teacher without making a description to specify the question positions.

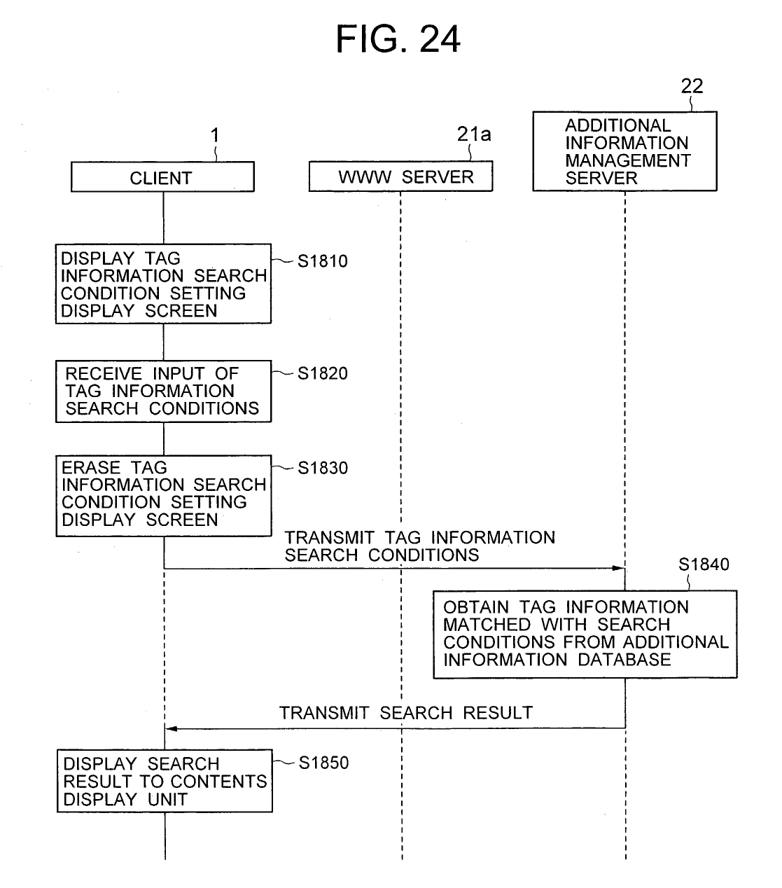

FIG. 24 shows a searching procedure of the tag information. When the client 1 receives the click of the tag information search button 5117 by the input receiving unit 112, it displays the tag information search condition setting display screen 55 by the additional information display unit 12 (step S1810).

On the tag information search condition setting display screen 55, the client 1 receives the search conditions about the color, period, implementor, and the description contents of the tag information serving as a search target by the input receiving unit 112 (step S1820).

When the client 1 receives the click of the OK button on the tag information search condition setting display screen 55 by the input receiving unit 112, it erases the tag information search condition setting display screen 55. Subsequently, the client 1 transmits the search conditions received in step S1820 to the additional information management server 22 via the communication processing unit 14 by using the communication protocol which has been predetermined between the client 1 and the additional information sharing server 2 (step S1830).

When the additional information management server 22 receives the search conditions transmitted from the client 1 by the communication processing unit 221, it obtains the tag information which meets the search conditions from the additional information database 25 by the additional information management unit 222. Subsequently, the additional information management server 22 transmits the obtained tag information as a search result to the client 1 via the communication processing unit 221 by using a communication protocol 32 (step S1840).

The client 1 receives the search result by the communication processing unit 14, forms table information according to the HTML by the additional information analysis unit 13 from the search result, and displays the table information as a search result to the WWW contents display unit 512 by the WWW browser processing unit 11 (step S1850).

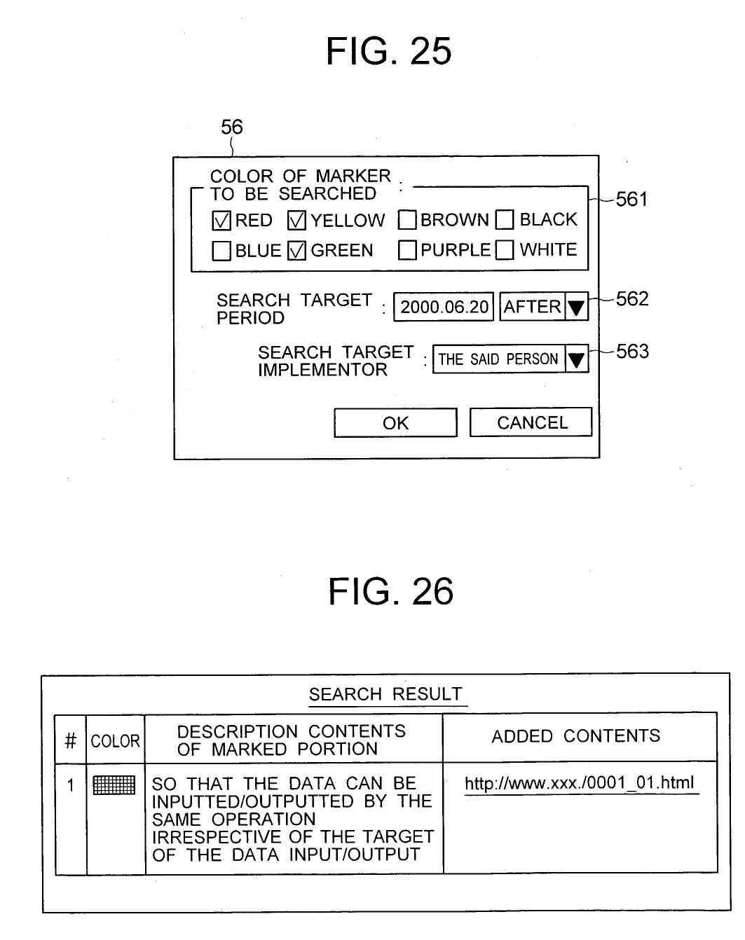

FIG. 25 shows a marker information search condition setting display screen 56. The color of the marker serving as a search target is received in a color designation area 561, a search target period is received in a search target period setting area 562, and a search target person is received in a search target person setting area 563, respectively.

FIG. 26 shows a search result display screen of the marker information. The color of the marker, the description of the marking portion, and the URL of the contents to which the marker has been added are displayed on this screen. When the client 1 receives the selection of the URL of the contents to which the marker has been added by the input receiving unit 112, it displays the contents of the URL and between the tag and the marker corresponding to the contents, one of them which meets the set display conditions is displayed. Thus, the user can form an abstract of the learning materials. Particularly, when learning English words by heart, by predetermining a marker which is added to the English words to be memorized, the user can extract only the English words to be memorized.

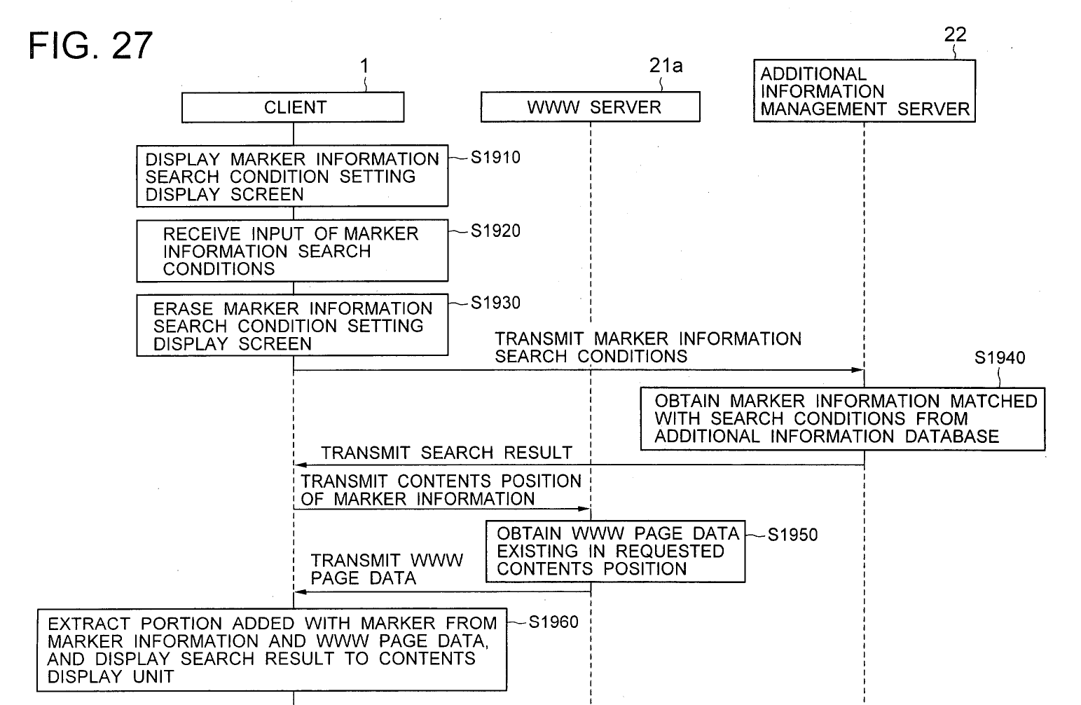

FIG. 27 shows a searching procedure of the marker information. When the user moves the cursor to the marker information search button 5118 and clicks the left button of the mouse, the additional information analysis unit 13 of the client 1 receives the position information of the cursor and the information showing the click of the left button of the mouse from the input receiving unit 112. Thus, the additional information analysis unit 13 instructs the additional information display unit 12 to display the marker information search condition setting display screen 56 (step S1910).

On the marker information search condition setting display screen 56, when the user inputs the search condition regarding the color, period, and implementor of the marker serving as a search target, the color, period, and implementor of the marker are received by the input receiving unit 112 (step S1920).

When the additional information analysis unit 13 of the client 1 determines from the position information sent from the input receiving unit 112 that the OK button on the marker information search condition setting display screen 56 has been selected by the user, it erases the marker information search condition setting display screen 56. Thus, the additional information analysis unit 13 transmits the search conditions set in step S1920 to the additional information management server 22 via the communication processing unit 14 by using the communication protocol which has been predetermined between the client 1 and the additional information sharing server 2 (step S1930).

The additional information management server 22 receives the search conditions transmitted from the client 1 by the communication processing unit 221 and obtains the marker information which meets the search conditions from the additional information database 25 by the additional information management unit 222. The additional information management server 22 transmits the obtained marker information as a search result to the client 1 via the communication processing unit 221 by using the communication protocol which has been predetermined between the client 1 and the additional information sharing server 2 (step S1940).

The client 1 receives the search result by the communication processing unit 14. Further, the client 1 obtains the URL showing the position of the contents from the search result and requests the WWW server 21a designated by the URL to transmit the WWW page data shown by the URL via the communication processing unit 14 by using the HTTP protocol. The WWW server 21a receives the WWW page data transmitting request by the communication processing unit 211a, analyzes it by the request processing unit 212a, and obtains the requested WWW page data from the WWW page database 23a. The WWW server 21a transmits the obtained WWW page data to the client 1 via the communication processing unit 211a by using the HTTP protocol.

(Step S1950).

The client 1 receives the WWW page data by the communication processing unit 14, forms table information according to the HTML by the additional information analysis unit 13 from the search result and the information obtained by extracting a portion corresponding to the marker range of the search result from the WWW page data, and displays the table information as a search result by the WWW browser processing unit 11 (step S1960).

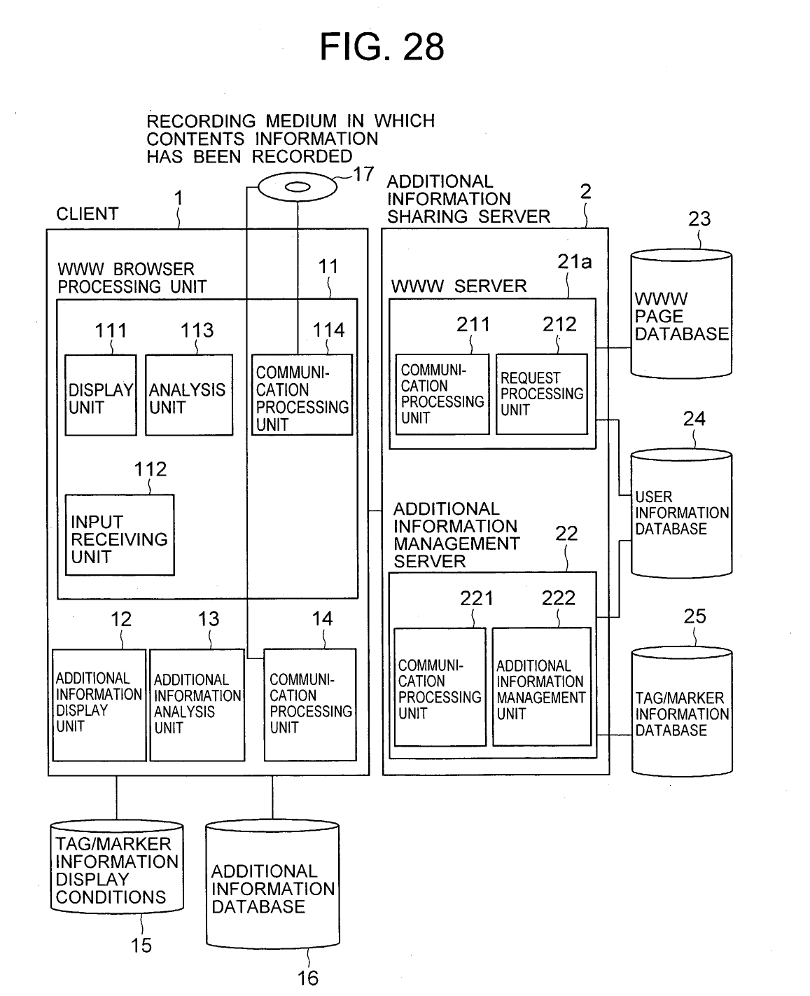

FIG. 28 shows an embodiment of the invention in the case where the contents exists on a recording medium and the recording medium is distributed to each user. The contents exists on a recording medium 17 in which contents information has been recorded. In a manner similar to the case of obtaining the contents information from the WWW server, a WWW browser can obtain contents information in a machine in which the WWW browser is operating. Therefore, the tag/marker information can be shared by using the recording medium 17 in which the same contents information has been recorded.

As described above, since the color information has been added to the tag paper and the marker information, the user can visually classify the tag paper and the marker information without executing any special operation. Since the color information has been added to the tag paper and the marker information, narrowing precision upon searching for the tag paper and the marker information can be raised.

Since the display conditions upon displaying the tag paper and the marker information can be set, the display of the tag paper and the marker information which are not necessary for the user can be suppressed. The WWW contents and the information which is necessary for the user can be displayed so that they can be easily seen.

Further, when the tag paper and the marker information are added, the person who can refer to the tag paper and the marker information is enabled to designate on a unit basis of the group and all registers, so that the information can be shared even by users who will be registered in future.

As described above, according to the invention, the additional information to the contents data can be used by a plurality of users.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A learning supporting program for displaying both contents information and additional information onto a display apparatus, comprising:
a program for selecting tag information or marker information designated by a user between the tag information and the marker information which have previously been stored in a database; and
a program for displaying said tag information or said marker information onto the contents information which is displayed on the basis of position information included in said selected tag information or marker information.

2. A learning supporting program for displaying both contents information and additional information onto a display apparatus, wherein
information of markers is displayed so as to overlap contents information, and when position information of a cursor coincides with position information of one of said marker information and an input signal is received from an input device, said marker information which coincides with the position information of said cursor is set to a non-display mode.

3. A learning supporting program for displaying both contents information and additional information onto a display apparatus, wherein
between tag information and marker information which have previously been stored in a database, the tag information or the marker information of a color designated by a user is selected and said selected tag information or marker information is displayed.

4. A learning supporting program according to claim 3, wherein when an instruction is made to said displayed tag information or marker information, the contents information is displayed on the basis of information to specify contents included in said tag information or said marker information, and said tag information or said marker information is displayed on said contents information on the basis of position information included in said tag information or said marker information.

5. A learning supporting system having a plurality of clients which are used by a user and a server for transmitting contents information stored in a database in response to a request from the client, wherein
said server has: a contents transmitting unit for collecting contents according to said request from the database in which the contents information have been stored on the basis of the request from the client and sending them to said client; and an additional information transmitting unit for collecting tag information or marker information on the basis of said collected contents and user information included in said request from a database in which the tag information and the marker information have been stored and transmitting the collected information to said client, and
said client has: an additional information selecting unit for selecting the tag information or the marker information designated by the user in said transmitted tag information or marker information; and a display unit for displaying said transmitted contents and the tag information or marker information selected by said additional information selecting unit.

6. A learning supporting system according to claim 5, wherein said client can search the tag information or the marker information by using the user to which the tag information or the marker information has been added and a color of a tag or a marker as search conditions.

7. A learning supporting system according to claim 5, wherein said client can designate as display conditions or search conditions of said tag information or said marker information on a unit basis of a group in which a plurality of users have been designated.

8. A learning supporting system according to claim 5, wherein said display unit of said client displays said tag information or said marker information to a relevant position on said contents on the basis of position information included in said tag information or said marker information.

9. A learning supporting method whereby a plurality of clients which are used by a user and a server for transmitting contents information are provided and said server transmits the contents information in response to a request from the client, wherein:
said server transmits the contents information to said client on the basis of the request from the client and transmits tag information or marker information on the basis of said contents information and user information included in said request; and
said client selects the tag information or the marker information designated by the user in said transmitted tag information or marker information and displays said transmitted contents information and said selected tag information or marker information.

10. A learning supporting method whereby a plurality of clients which are used by a user and a server for transmitting contents information are provided and said server transmits the contents information in response to a request from the client, wherein:
information of a color of tag information or marker information which is displayed from one of said clients and information of the user are transmitted to said server;
when the contents information is transmitted in response to the request from the client, the server which received the information of said color and the information of the user transmits the information of said color and the information of the user to said client on a requesting source side; and
when said client on the requesting source side forms the tag information or marker information, it forms said tag information or said marker information in the color according to said transmitted color information.
